(19) United States
(12) Patent Application Publication
(10) Pub. No.: US 2004/0005385 A1
(43) Pub. Date: Jan. 8, 2004

(54) Stackable, pre-loaded drinking cup

(76) Inventor: Charles Robert Emig, Alpine, UT (US)

Correspondence Address: Angus C. Fox, III, 4093 N. Imperial Way, Provo, UT, 84604-5386, US

(21) Appl. No.: 10/189,914

(22) Filed: Jul. 5, 2002

(51) Int. Cl. A23L 1/00

(52) U.S. Cl. 426/86

(57) ABSTRACT

A pre-loaded drinking cup includes a carbonate and acid-containing compacted soluble, dry, solid concentrate is preferably adhered, in pellet form, primarily to the inner bottom surface of a stackable, frustro-conical cup. A sugar-sweetened concentrate, including sugar, flavoring and coloring, may be melted and extruded into fibers, much like cotton candy. The acid particles and carbonate particles may then be mixed with the fibers and compacted into a laminar pellet, which may then be adhered to the bottom of the cup using a low temperature, moisture-free adhesive, such as a film of wax. Alternatively, a pellet is formed from alternating layers of acid particles, food material particles such as a sugar-flavoring or soup base, and carbonate particles. Each layer may be applied as an aqueous slurry and allowed to dry before the next layer is applied. For yet another embodiment of the invention, the dry ingredients are mixed with a binder, compacted into a pellet that is adhered to the bottom of the cup. For still another embodiment, dry ingredients are combined with a polysaccharide material and applied as an aqueous solution to the inner surfaces of the cup. A final embodiment utilizes a polysaccharide film to cover and seal dry ingredients at the bottom of the cup.

### BACKGROUND OF THE INVENTION

1. Field of the Invention

This invention generally relates to cups for holding a consumable liquid, and, more particularly, to cups which contain a soluble food or drink product which may be dissolved when the cup is filled with water.

2. Description of the Prior Art

Cups having pre-loaded quantities of a consumable concentrate material are well represented in the prior art. One of the earliest examples is U.S. Pat. No. 1,770,118, issued to William M. Wallace in 1928. The invention consists of a plurality of nested frustoconical drinking cups, each of which has a drink flavoring substance adhered to the bottom thereof and covered with a removable sealing disk. A later example is U.S. Pat. No. 2,062,897, issued to Charles O. R. Michel, et al. in 1931, which discloses a liquid-impervious cup having a soluble substance adhered to the sides and bottom thereof. When the cup is filled with water, the soluble substance dissolves to form a beverage. The soluble substance may be covered by an optional soluble film formed from a consumable material such as gelatin. U.S. Pat. No. 3,202,275, issued to Roy G. Loughary in 1965, discloses several additional embodiments of a pre-loaded dispenser cup. One of the more unique embodiments utilizes a gelatinous layer to cover a soluble concentrate lining. Another pre-loaded dispenser cup is disclosed in U.S. Pat. No. 4,312,889, which issued to Stephen T. Melcheimer in 1982. A concentrate is placed in the bottom of the cup either as a slurry of solids in a liquid, as a powdered solid, or as a powdered solid adhered to a layer of gelatin contained in the cup. The concentrate includes a non-volatile, water miscible liquid, such as glycerine, or a powdered solid wetting agent, such as polyethylene glycol or polyoxyethylene polymer.

There are several problems associated with the prior art pre-loaded drinking cups. One problem is that, in the absence of agitation, complete solvation of the beverage concentrate may be difficult to achieve. Another is that efforts to foster solvation of the concentrate by increasing the exposed surface area of thereof may lead to both stackability problems and increased fragility of a brittle anhydrous concentrate if sprayed or deposited as a thin layer on the sides of the cup. As an example of the interrelatedness of the above noted problems, pre-loaded cups which place the concentrate at the bottom of the cup have improved stackability, but greatly increased solvation times. Another example, the additional wall thickness created by positioning the concentrate on the inner sidewalls of a frustro-conical, as disclosed by both the Loughary and the Michel, et al. patents, greatly reduces the nestability of the cups, resulting in tall stacks of very few cups. As a further example, the Loughary patent suggests that a pre-loaded cup may have an inner coating made from an efferevescent concentrated substance or a material such as Alka-Seltzer®, or an acetyl salicylic acid containing powder made in accordance with U.S. Pat. No. 2,221,485, issued in 1940 to Frederick J. Zimmermann, or an effervescing composition in particle form covered by U.S. Pat. No. 3,082,091, issue in 1963 to Pierre F. Smith, et al. However, no explanation is provided relating to the method used to adhere the presumably brittle compounds to the inner surfaces of the cup. The problem of adhesion would be compounded by flexibility of the cup, itself.

A number of rapidly-dissolving, flavored and sweetened drink mixes have been developed over the years. U.S. Pat. No. 4,343,819 discloses a quick-dissolving, sucrose-containing drink mix that is prepared by binding particles of a water-soluble carbonate on the surface of sucrose granules and mixing the treated granules with a particulate or powdered acid. When the drink mix is solvated, the acid particles react with the carbonate particles to generate carbon dioxide, which promotes rapid dissolution of the sucrose.

Pullulan is a viscous water-soluble neutral polysaccharide secreted by the fungus Aureobasidium pullulans (hereinafter referred to as A. pullulans and by several other similar microbes. A. pullulans is included in the American Type Culture Collection under one genus and species designation. The fungus is commonly isolated from forest litter, natural waters, industrial waste waters, paint surfaces, plastic, wood, leather, plant surfaces and canvass, and as an opportunistic pathogen from certain patients. A. pullulans is a polymorphic fungus. Three distinctive forms predominate: elongated branched septate filaments, large chlamydospores and smaller, elliptical yeastlike single cells. Each of the three forms can be seen both in liquid media and on solid agar surfaces as part of a single colony.

The polysaccharide pullulan has been used in diverse applications. Its uses include: transparent films; oxygen-impermeable, tasteless, odorless coatings for food; viscosity control agents; adhesives for construction materials; fibers; and dielectrical materials in the form of cyanoethylpullulan. The purity of the polymer and molecular weight are important properties for the end uses.

An undesirable characteristic feature of A. pullulans is that it produces a dark pigment which is a melanin-like compound, and appears dark green to black in color. Though the contaminating pigment can be removed by subjecting recovered pullulan to a multistep decoloration treatment with activated charcoal followed by filtration, U.S. Pat. No. 6,387,666 to Thorne, et al. discloses a method for obtaining a substantially biologically pure culture strain of A. pullulans which exhibits reduced pigmentation of the excreted polysaccharide. Excreted pullulan from such a strain is of sufficient clarity that no decoloration treatment is necessary.

### SUMMARY OF THE INVENTION

Several embodiments of an improved pre-loaded drinking cup are provided which overcome both the stackability and solubility problems inherent the prior art. A carbonate and acid-containing compacted soluble, dry, solid concentrate is preferably adhered primarily to the inner bottom surface of a stackable, frustro-conical cup. The concentrate may not be applied to the cup as an aqueous solution and subsequently allowed to dry, as this would cause premature reaction of the carbonate particles with the acid particles. Nor may the concentrate be applied as a molten mass, as temperatures much over 40° C. typically cause carbonate compounds to decompose. Therefore, it must be applied to the cup in a substantially moisture-free form, or in a manner that will not cause the acidic and basic particles to interact.

For a first embodiment of the invention, a sugar sweetened concentrate, including sugar, flavoring and coloring, may be melted and extruded into fibers, much like cotton candy. The acid particles and carbonate particles may then be mixed with the fibers and compacted into a laminar pellet, which may then be adhered to the bottom of the cup using a low temperature, moisture-free adhesive, such as a film of wax. For a second embodiment of the invention, a pellet is formed from alternating layers of acid particles, food material particles such as a sugar-flavoring or soup base, and carbonate particles. Each layer may be applied as an aqueous solution and allowed to dry before the next layer is applied. The pellets may be created as a large wafer and, then, stamped into pellet-sized shaped. In order to increase the solubility of the pellets, the pellet may be perforated during the stamping process with a plurality of small holes which allow the components from each layer to mix together when water is poured on top of the pellet. For a third embodiment of the invention, the dry ingredients are mixed together in the presence of a binder, such as propylene glycol, compacted into a pellet and placed at the bottom of the cup. For a fourth embodiment of the invention, the various ingredients may be applied by various nozzles to the inside of the cup as aqueous solutions in alternating layers, with the sugar and flavoring layer being interposed between acidic and basic solutions. The solutions are applied in the presence of sufficient heat and optionally, a partial vacuum, to dry each layer before the subsequent layer is applied. The sprayed solutions may be charged opposite to the cup in order to minimize waste and to ensure that the sprayed particles are applied to the cup and not atomized.

For soup based concentrates, dry ingredients are mixed together in the presence of a binder, compacted into a pellet and placed at the bottom of the cup.

Additional embodiments of an improved pre-loaded drinking cup incorporate polysaccharide or polysaccharide-containing films. The use of such films overcomes the problems of stackability, solubility of the concentrate, and fragility of the concentrate. Though pullulan is considered to be the preferred polysaccharide material for use with the present invention, other polysaccharide films may be substituted therefore. Substitute polysaccharide films include those made from hydroxyethyl cellulose, hydroxyproplymethyl cellulose, hydroxypropyl cellulose, polyvinyl pyrrolidone, carboxymethyl cellulose, polyvinyl alcohol, sodium alginate, polyethylene glycol, tragacanth gum, guar gum, acacia gum, arabic gum, polyacrylic acid, methylmethacrylate copolymer, carboxyvinyl polymer, amylose, high amylose starch, hydroxypropylated high amylose starch, dextrin, pectin, chitin, chitosan, levan, elsinan, collagen, gelatin, zein, gluten, soy protein isolate, whey protein isolate, casein, mixtures thereof, or mixtures of the foregoing with pullulan.

For a fifth embodiment of the invention, a beverage or soup concentrate having no carbonate and acid particles, is mixed in aqueous solution with a desired polysaccharide material. The solution is applied to the inner surfaces of the cup and allowed to dry. A variety of edible oils, such as vegetable oils, may be added to the mixture, preferably in combination with an emulsifier, to impart additional plasticity and flexibility to the deposited films.

For a sixth embodiment of the invention, a carbonate and acid-containing compacted soluble, dry, solid concentrate is positioned preferably in the lower-most portion of a stackable, frustro-conical cup. The concentrate, of course, may not be applied to the cup as an aqueous solution and subsequently allowed to dry, as this would cause premature reaction of the carbonate particles with the acid particles. Nor may the concentrate be applied as a molten mass, as temperatures much over 40° C. typically cause carbonate compounds to decompose. Therefore, it is placed in the cup in a substantially moisture-free form. A generally circular piece of polysaccharide film is then placed over the concentrate and bonded to the sidewalls of the cup, thereby sealing the concentrate at the bottom of the cup. The concentrate may be either a drink base or a soup base. When water is poured into the cup, the polysaccharide film will dissolve, thus allowing the carbonate and acid particles to react and speed the solvation of concentrate. The carbonate and acid particles, which are incorporated in the concentrate, are used primarily as a mixing tool, and not to impart significant levels of carbonation to the reconstituted mixture.

If a pre-loaded drinking cup is to be successful in the marketplace, the contained beverage concentrate must be firmly anchored to the cup. In addition, the concentrate must be readily dissolvable. That is to say that the consumer should be able to simply fill the cup with water, preferably without having to agitate the mixture. What is needed is an improved pre-loaded drinking cup that achieves these goals, while still remaining affordable, stackable, and readily manufacturable.

### BRIEF DESCRIPTION OF THE DRAWINGS

FIG. 1 is a side elevational view of a spray apparatus for producing a multilayer, dehydrated, carbonated drink concentrate wafer, the apparatus being shown depositing an acid slurry layer;

FIG. 2 is a side elevational view of the spray apparatus of FIG. 1 shown depositing a first food or drink concentrate layer after the acid slurry layer has dried;

FIG. 3 is a side elevational view of the spray apparatus of FIG. 1, shown depositing a carbonate slurry layer after the food or drink concentrate layer has dried;

FIG. 4 is a side elevational view of the spray apparatus of FIG. 1, shown depositing a second food or drink concentrate layer after the carbonate slurry layer has dried;

FIG. 5 is a front elevational view of the spray apparatus of FIG. 1, shown depositing the second food or drink concentrate layer atop the dried carbonate slurry layer;

FIG. 6 is a top plan view of the multi-layer, dehydrated, carbonated food or drink concentrate wafer, formed using the apparatus and process shown in FIGS. 1 through 4, after it has been stamped into pellets;

FIG. 7 is a top plan view of a single multi-layer, dehydrated, carbonated food or drink concentrate pellet after having been singulated from the wafer shown in FIG. 6;

FIG. 8 is a cross-sectional view of first, second, or third embodiment stackable drinking cup having a food or drink concentrate pellet adhered to the bottom interior thereof;

FIG. 9 is a cross-sectional view of seven stacked pre-loaded drinking cups, each of which is identical to that shown in FIG. 8;

FIG. 10 is a cross-sectional view of a fourth or fifth embodiment pre-loaded cup, having a beverage concentrate incorporated in a polysaccharide film adhered to the sidewalls and bottom thereof;

FIG. 11 is a cross-sectional view of five nested fourth or fifth embodiment preloaded cups;

FIG. 12 is a cross-sectional view of a sixth embodiment pre-loaded cup, having a beverage concentrate in power or granular form positioned in the bottom thereof and covered with a polysaccharide film, which on the edges, is adhered to the inner walls of the cup; and

FIG. 13 is a cross-sectional view of seven nested sixth embodiment pre-loaded cups.

### DETAILED DESCRIPTION OF THE PREFERRED EMBODIMENTS

An improved pre-loaded drinking cup is provided which overcomes both the stackability and solubility problems inherent in the prior art. A carbonate and acid-containing soluble, dry, solid concentrate is preferably adhered primarily to the inner bottom surface of a stackable, frustro-conical cup. Various embodiments of the improved pre-loaded drinking cup will now be described with reference to the attached drawing figures.

The problems associated with the pre-loaded cups of the prior art are long solvation times for cups pre-loaded only on the bottom inner surface and poor stackability for cups pre-loaded on both the bottom and sidewall inner surfaces. Because discardable cups of frustro-conical shape typically increase in diameter from bottom to the top thereof only an amount necessary to provide maximum stackability, pre-loading such cups on the sidewalls, to increase the exposed surface area of the concentrate, greatly increases the height of multiple stacked cups. Thus, so as to minimize stackability problems, the pre-loaded cups of the present invention are pre-loaded only at the bottom. However, by pre-loading the cups at the bottom, the thickness of the pre-loaded concentrate must, necessarily, be increased and the surface area decreased. In order to avoid the long solvation times inherent with the prior art cups which were pre-loaded only at the bottom, a pre-loaded concentrate is provided which incorporates both acid and carbonate particles. Edible organic acid compounds, such as citric, fumaric, tartaric, malic or lactic acids, either singly or in combination, are preferred for this application. Usable carbonates include sodium carbonate, sodium bicarbonate, sodium sesquicarbonate, potassium carbonate, potassium bicarbonate, calcium carbonate, ammonium carbonates, and calcium-magnesium carbonate, either singly or in combination. When water is added to the cup, the acid and carbonate particles react with one another to liberate carbon dioxide, thereby breaking up the concentrate and reducing the salvation time. Of course, the concentrate may not be applied to the bottom of the cup as an aqueous slurry, as the acid and carbonate particles would prematurely react. Nor may the concentrate be applied as a molten mass, as temperatures much over 40° C. typically cause carbonate compounds to decompose. Therefore, it must be applied to the cup in a substantially moisture-free form, or in a manner that will not cause the acidic and basic particles to interact.

For a first embodiment of the invention, a sugar sweetened concentrate, including sugar, flavoring and coloring, may be melted and extruded into fibers, using equipment similar, or identical, to that used to manufacture cotton candy. The acid particles and carbonate particles may then be mixed with the fibers and compacted into a pellet, which may then be adhered to the bottom of the cup using a low temperature, moisture-free adhesive, such as a film of wax. Alternatively, the acid may be incorporated into the sugar fibers, along with the sugar, flavoring and coloring. The carbonate containing compound(s) are then mixed with the fibers and compacted into a pellet.

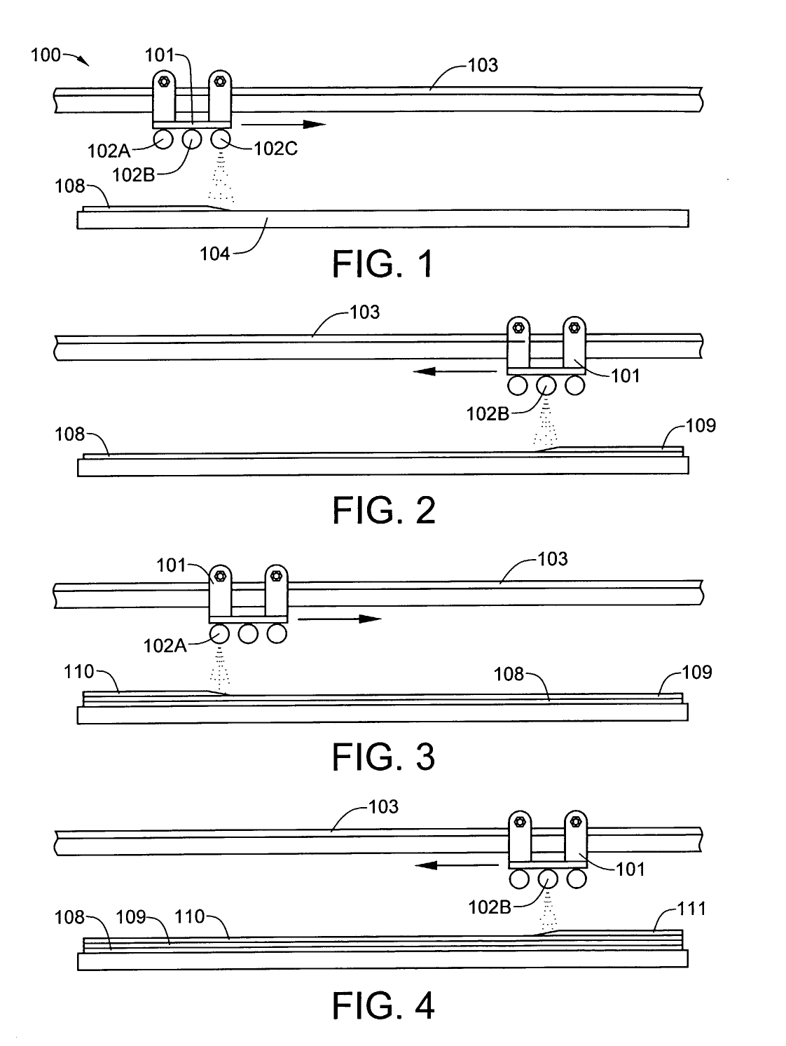

For a second embodiment of the invention, a pellet is formed from alternating layers of acid particles, food material particles such as a sugar-flavoring or soup base, and carbonate particles. Each layer may be applied as a thick aqueous solution and allowed to dry before the next layer is applied. In order to speed evaporation of the water from the applied layers, the process may be performed in the presence of heat and reduced pressure (a partial vacuum). It is important that a sugar or soup base layer be placed over each acid layer and each carbonate layer so that the acid will not react with the carbonate layer. FIGS. 1 through 4 are representative of this layered formation method. In FIG. 1, a spray apparatus 100, including a trolley 101 having three spray tubes 102A, 102B and 102C moves on rails 103 bidirectionally over a heated, Teflon®-coated plate 104. Spray tube 102A emits a pressurized organic acid slurry 105; spray tube 102B emits a pressurized food concentrate slurry 106, which may include one or more sugars, flavorings, colorings, and optionally vitamins and an antifoaming agent; spray tube 102C emits a pressurized carbonate slurry 107. On a first pass shown in FIG. 1, a carbonate slurry layer 108 is deposited and allowed to dry. On a second pass shown in FIG. 2, a food concentrate slurry layer 109 is deposited on top of the dry acid layer 108 and is, then, allowed to dry. On a third pass shown in FIG. 3, an organic acid slurry layer 110 is deposited on top of the dry food concentrate layer 109, and it is, then, allowed to dry. On fourth pass shown in FIG. 4, another food concentrate slurry layer 111 is deposited on top of the dry carbonate layer 110, and it is, then, allowed to dry. The fifth layer is a repeat of the carbonate slurry layer 108, and so forth. Drying of each layer must be sufficiently rapid to prevent acid or carbonate particles from diffusing more than half way through a food material layer. The spraying of the layers is much like ink jet printing. Drying of the ink occurs quickly enough that the colors do not run together.

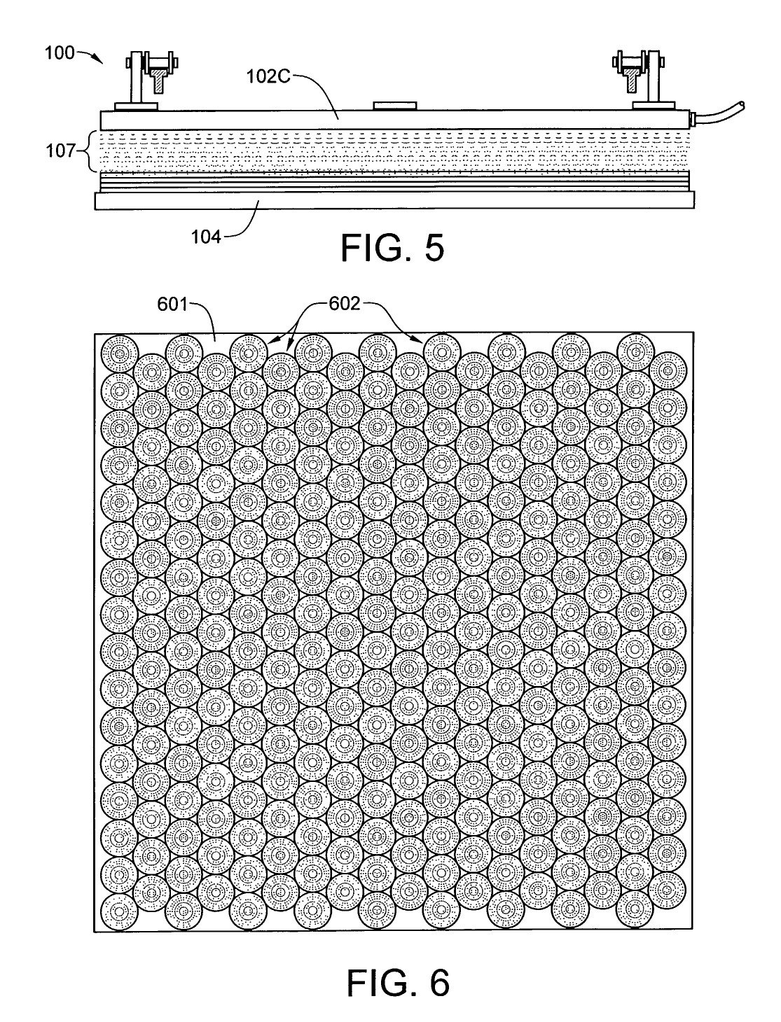

Referring now to FIG. 5, the spray apparatus 100 of FIGS. 1 through 4 is seen in a front view. It will be noted that each spray (only tube 102C is visible in this view) extends across the heated plate 104, and that the spray (in this case the carbonate slurry 107) also extends from one side of the heated plate 104 to the other.

FIG. 6 is representative of the result of the process shown in FIGS. 1 through 5. Once a wafer 601 of appropriate thickness has been deposited by the build-up of multiple layers, the wafer is stamped into pellets 602. In order to shorten the time required for acid and carbonate particles to mix when water is poured over a pellet, each pellet may be perforated during the stamping process, so as to provide a path for water molecules to travel between layers, thereby speeding the mixing of acid and carbonate particles. Each pellet may then be adhered to the bottom of a cup, using a non-aqueous, low-temperature adhesive, such as wax.

For a third embodiment of the invention, the dry ingredients are mixed together in the presence of a binder, such as propylene glycol, compacted into a pellet and placed at the bottom of the cup. The pellet may be perforated in order to decrease solvation times.

For soup based concentrates, dry ingredients may be mixed together in the presence of a binder, compacted into a pellet and adhered to the bottom of the cup.

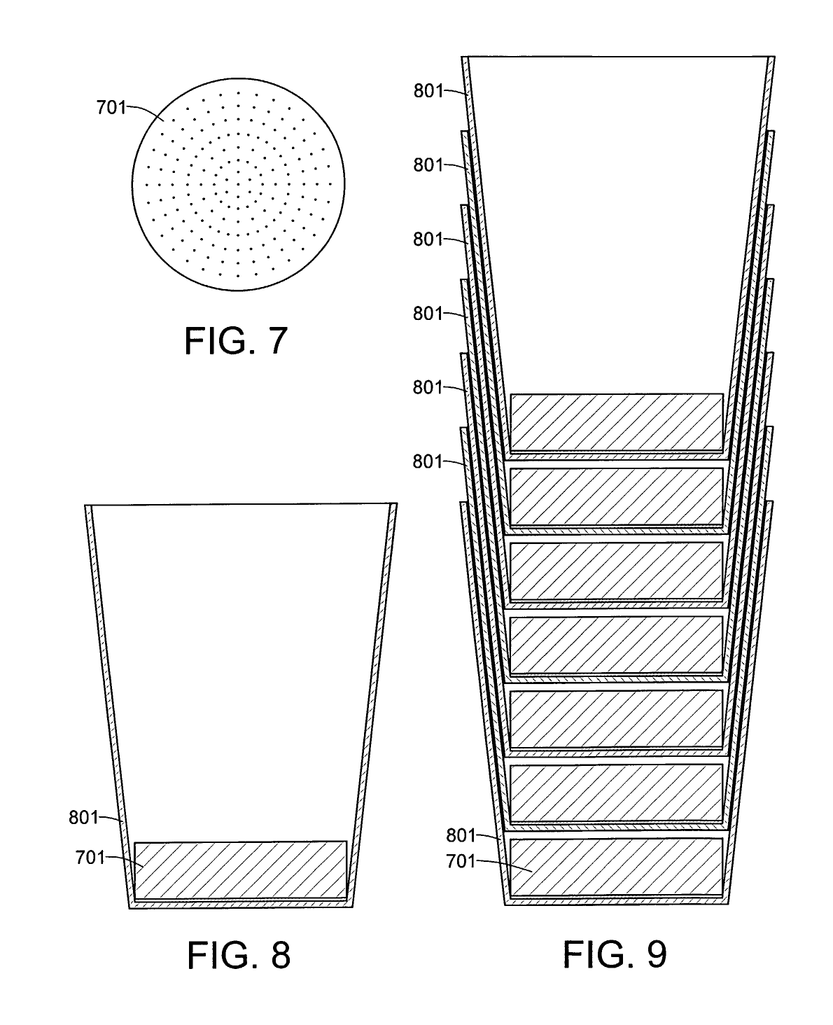

Referring now to FIG. 7, a single, pellet 602 is shown that is close to actual size. Each pellet 602 is shown as having 167 perforations therein, each of which provides a path for solvated carbonate and acid particles, which were deposited in different layers, to quickly interact.

Referring now to FIG. 8, the pellet 602 of FIG. 7 has been secured to the bottom of a drinking cup shell 801 using a low temperature, moisture-free adhesive, such as a film of wax, resulting in a second embodiment pre-loaded drinking cup 802. This drawing figure may also be considered representative of the first and third embodiment pre-loaded drinking cups.

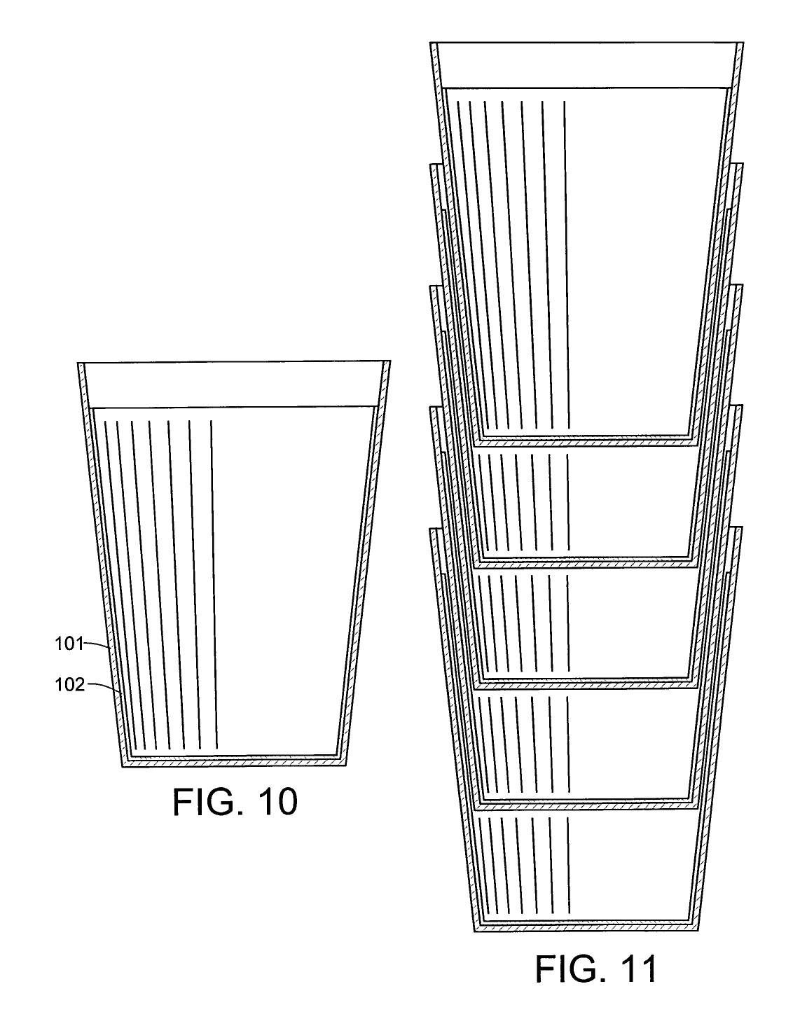

Referring now to FIG. 9, seven cups 802A through 802G, which are identical to that shown in FIG. 8, have been nested in a stacked arrangement. It will be noted that the presence of a pellet 602 on the bottom of each cup does not impede stackability.

For a fourth embodiment of the invention, the various ingredients may be applied by various nozzles to the inside of the cup as aqueous solutions in alternating layers, with the sugar and flavoring layer being interposed between the applications of acid and carbonate. The solutions are applied in the presence of sufficient heat to dry each layer before the subsequent layer is applied. The sprayed solutions may be charged opposite to the cup in order to minimize waste and to ensure that the sprayed particles are applied to the cup and not atomized. The process may be performed in the same manner as shown in FIGS. 1 through 5. Of course, each cup is coated individually, and the built-up material is allowed to remain adhered to the inner surface of the cup.

For a fifth embodiment of the invention, a beverage or soup concentrate having no carbonate and acid particles, is mixed in aqueous solution with a desired polysaccharide material. The solution is applied to the inner surfaces of the cup, preferably by spraying, and allowed to dry. A variety of edible oils, such as vegetable oils, may be added to the mixture, preferably in combination with an emulsifier, to impart additional plasticity and flexibility to the deposited films. Though pullulan is considered to be the preferred polysaccharide material for use with the present invention, other polysaccharide films may be substituted therefore. Substitute polysaccharide films include those made from hydroxyethyl cellulose, hydroxyproplymethyl cellulose, hydroxypropyl cellulose, polyvinyl pyrrolidone, carboxymethyl cellulose, polyvinyl alcohol, sodium alginate, polyethylene glycol, tragacanth gum, guar gum, acacia gum, arabic gum, polyacrylic acid, methylmethacrylate copolymer, carboxyvinyl polymer, amylose, high amylose starch, hydroxypropylated high amylose starch, dextrin, pectin, chitin, chitosan, levan, elsinan, collagen, gelatin, zein, gluten, soy protein isolate, whey protein isolate, casein, mixtures thereof, or mixtures of the foregoing with pullulan.

As a special feature of the fifth embodiment pre-loaded drinking cup, the aqueous solution of beverage concentrate may be applied to the inner surfaces of the cup by the sprayers in a decorative pattern. In order to accomplish this task, the sprayer(s) may be computer controlled. The decorative pattern may be, for example, a brand name logo or a geometric pattern.

Referring now to FIG. 10, a single fourth or fifth embodiment pre-loaded drinking cup 1001 is uniformly coated with a layer 1002 of dehydrated drink concentrate on the major portion of the inner side and bottom surfaces.

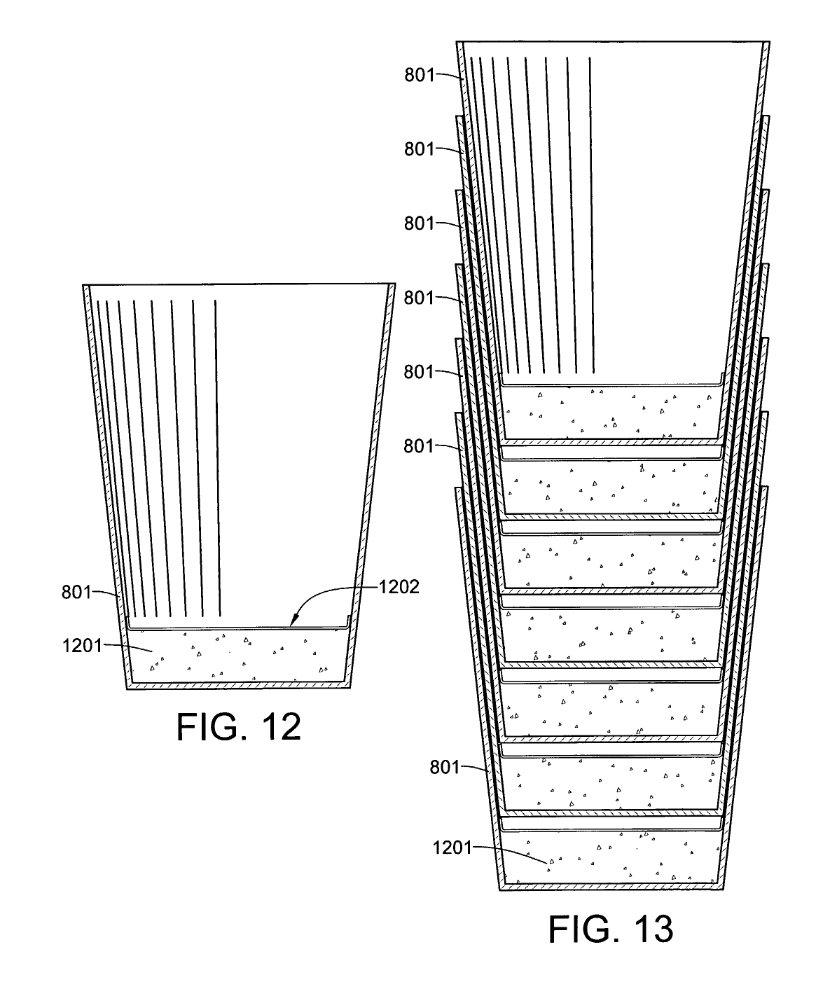

Referring now to FIG. 11, five fourth or fifth embodiment pre-loaded drinking cups 1001A to 1001E are nested in a stacked arrangement. It will be noted that, in spite of the relatively minimal thickness of the drink concentrate layer, the cups do not stack as well as cups having the drink concentrate applied to only the interior bottom surface thereof. Five stacked cups of the fourth or fifth embodiment have a total height that is greater than seven of the first, second, third or sixth embodiment pre-loaded cups.

Referring now to FIG. 12, is a cross-sectional view of a sixth embodiment preloaded cup 1200, having a beverage concentrate 1201 in power or granular form positioned in the bottom thereof and covered with a polysaccharide film 1202, which on the edges 1203, is adhered to the inner walls of the cup shell 801 using a low temperature, moisture-free adhesive, such as a film of wax. Water soluble rice paper may be substituted for the polysaccharide film. As is the case for the fifth embodiment pre-loaded cup, though pullulan is considered to be the preferred polysaccharide material for use with the present invention, other polysaccharide films may be substituted therefore. Substitute polysaccharide films include those made from hydroxyethyl cellulose, hydroxyproplymethyl cellulose, hydroxypropyl cellulose, polyvinyl pyrrolidone, carboxymethyl cellulose, polyvinyl alcohol, sodium alginate, polyethylene glycol, tragacanth gum, guar gum, acacia gum, arabic gum, polyacrylic acid, methylmethacrylate copolymer, carboxyvinyl polymer, amylose, high amylose starch, hydroxypropylated high amylose starch, dextrin, pectin, chitin, chitosan, levan, elsinan, collagen, gelatin, zein, gluten, soy protein isolate, whey protein isolate, casein, mixtures thereof, or mixtures of the foregoing with pullulan.

For the first, second, third and sixth embodiments of the invention, if the reaction of the acid and carbonate particles is employed primarily to decrease solvation times of the concentrate, the acid component of the concentrate is about ten percent or less, by weight. The carbonate component of the concentrate is about half the weight of the acid component. If a carbonated beverage is the desired result, the composition of acid and carbonate may be proportionately increased. Other ingredients for the concentrate may include buffering salts, such as alkali metal and alkaline earth metal phosphates, citrates, acetates, and so forth, in an amount of about one percent or less; clouding agents; anti-foaming agents; and vitamins.

Referring now to FIG. 13, is a cross-sectional view of seven nested sixth embodiment pre-loaded cups 1201A-1201G.

Although only several embodiments of the invention have been disclosed herein, it will be obvious to those of ordinary skill in the art, that changes and modifications may be made thereto, without departing from the spirit and scope of the invention as hereinafter claimed.

What is claimed is:

1. A pre-loaded drinking cup comprising:
a generally frustro-conical wall portion having an axis of symmetry and inner and outer surfaces;
a base portion continuous and unitary with said wall portion, and generally perpendicular to the axis of symmetry and having inner and outer surfaces;
a water-soluble, ingestible, dehydrated beverage concentrate adhered primarily to the inner surface of said base portion, said concentrate characterized by effervescence during solvation in water.

2. The pre-loaded drinking cup of claim 1, wherein said cup is nestable within an identical cup.

3. The pre-loaded drinking cup of claim 1, wherein said water-soluble, ingestible, dehydrated beverage concentrate is a flavored, sugar-containing compound.

4. The pre-loaded drinking cup of claim 3, wherein said water-soluble, ingestible, dehydrated beverage concentrate is in the form of a pellet which is attached to an inner surface of the base portion with a low-temperature adhesive.

5. The pre-loaded drinking cup of claim 4, wherein said pellet comprises compacted sugar fibers mixed with carbonate particles and organic acid particles, said carbonate particles and said organic acid particles interacting to form carbon dioxide gas when water is poured into the cup.

6. The pre-loaded drinking cup of claim 4, wherein said pellet comprises compacted fibers containing both sugar and at least one organic acid, said compacted fibers being mixed with carbonate particles.

7. The pre-loaded drinking cup of claim 4, wherein said pellet comprises at least one organic acid layer, at least one carbonate layer, and a sugar layer interposed between each organic acid and carbonate layer pair.

8. The pre-loaded drinking cup of claim 1, wherein said water-soluble, ingestible, dehydrated beverage concentrate is a soup base mixture containing both organic acid particles and carbonate particles, said mixture held together by a binding agent.

9. The pre-loaded drinking cup of claim 3, wherein said water-soluble, ingestible, dehydrated beverage concentrate further comprises compounds selected from the group consisting of colorants, vitamins, anti-foaming agents, and clouding agents.

10. The pre-loaded drinking cup of claim 3, wherein said water-soluble, ingestible, dehydrated beverage concentrate is applied to the inner surface of the cup as at least one layer containing an organic acid, at least one layer containing a carbonate, and a sugar containing layer interposed between each organic acid containing layer and each carbonate containing layer.

11. A pre-loaded drinking cup comprising:
a generally frustro-conical wall portion having an axis of symmetry and inner and outer surfaces;
a base portion continuous and unitary with said wall portion, and generally perpendicular to the axis of symmetry and having inner and outer surfaces;
a powdered, water-soluble, dehydrated beverage concentrate positioned within the cup and covering the inner surfaces of the base portion, said beverage concentrate including organic acid particles and carbonate particles which interact with one another to release carbon dioxide gas when the pellet is solvated in water; and
a water soluble a polysaccharide film covering the powered beverage concentrate and adhered to the inner surfaces of said wall portion with a low temperature, non-water-soluble adhesive.

12. The pre-loaded drinking cup of claim 11, wherein the water soluble polysaccharide film is selected from the group of compounds consisting of pullulan, hydroxyethyl cellulose, hydroxyproplymethyl cellulose, hydroxypropyl cellulose, polyvinyl pyrrolidone, carboxymethyl cellulose, polyvinyl alcohol, sodium alginate, polyethylene glycol, tragacanth gum, guar gum, acacia gum, arabic gum, polyacrylic acid, methylmethacrylate copolymer, carboxyvinyl polymer, amylose, high amylose starch, hydroxypropylated high amylose starch, dextrin, pectin, chitin, chitosan, levan, elsinan, collagen, gelatin, zein, gluten, soy protein isolate, whey protein isolate, casein, and mixtures thereof.

13. The pre-loaded drinking cup of claim 11, wherein said cup is nestable within an identical cup.

14. The pre-loaded drinking cup of claim 11, wherein said water-soluble, dehydrated beverage concentrate is a flavored, sugar-containing compound.

15. The pre-loaded drinking cup of claim 11, wherein said polysaccharide films dissolves and said carbonate particles react with said organic acid particles to form carbon dioxide gas when water is poured into the cup.

16. The pre-loaded drinking cup of claim 11, wherein said water-soluble, dehydrated beverage concentrate is a soup base mixture containing both organic acid particles and carbonate particles.

17. The pre-loaded drinking cup of claim 11, wherein said water-soluble, dehydrated beverage concentrate further comprises compounds selected from the group consisting of colorants, vitamins, anti-foaming agents, and clouding agents.

18. A pre-loaded drinking cup comprising:
a generally frustro-conical wall portion having an axis of symmetry and inner and outer surfaces;
a base portion continuous and unitary with said wall portion, and generally perpendicular to the axis of symmetry and having inner and outer surfaces;
a water-soluble, dehydrated beverage concentrate applied to the inner surfaces of the cup, said concentrate including a polysaccharide binder.

19. The pre-loaded drinking cup of claim 18, wherein said polysaccharide binder is selected from the group of compounds consisting of pullulan, hydroxyethyl cellulose, hydroxyproplymethyl cellulose, hydroxypropyl cellulose, polyvinyl pyrrolidone, carboxymethyl cellulose, polyvinyl alcohol, sodium alginate, polyethylene glycol, tragacanth gum, guar gum, acacia gum, arabic gum, polyacrylic acid, methylmethacrylate copolymer, carboxyvinyl polymer, amylose, high amylose starch, hydroxypropylated high amylose starch, dextrin, pectin, chitin, chitosan, levan, elsinan, collagen, gelatin, zein, gluten, soy protein isolate, whey protein isolate, casein, and mixtures thereof.

20. The pre-loaded drinking cup of claim 18, wherein said beverage concentrate contains sugar, flavorings and colorants.

21. The pre-loaded drinking cup of claim 18, wherein said cup is nestable within an identical cup.

22. The pre-loaded drinking cup of claim 18, wherein said water-soluble, dehydrated beverage concentrate is a soup base mixture.

23. The pre-loaded drinking cup of claim 18, wherein said water-soluble, dehydrated beverage concentrate is applied to the inner surfaces of the cup in a decorative pattern.
